(19) United States
(12) Patent Application Publication
(10) Pub. No.: US 2007/0000356 A1
(43) Pub. Date: Jan. 4, 2007

(54) RATCHETING DEVICE

(75) Inventor: Michael R. Staples, Mauldin, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Professional Tool Products, LLC.

(21) Appl. No.: 11/427,136

(22) Filed: Jun. 28, 2006

Related U.S. Application Data
(60) Provisional application No. 60/695,158, filed on Jun. 29, 2005.

(51) Int. Cl. B25B 13/46

(52) U.S. Cl. 81/63.1

(57) ABSTRACT

A ratcheting device is provided, comprising a sleeve member defining an axially-disposed tool bore and having a rotatably fixed gear member. A ratchet body defines an axial sleeve bore for receiving the sleeve and gear members, and two parallel ratchet member bores extending transversely to the sleeve bore through a respective opening in an outward circumferential surface of the ratchet body. The ratchet member bores are opposed about and intersect the sleeve bore. A control ferrule extends coaxially about the ratchet body. First and second ratchet members received by the ratchet member bores are normally biased outwardly toward the corresponding opening, and each includes a gear element for engaging the gear member. A bearing device is engaged with the end of the respective ratchet member toward the opening. The bearing devices cooperate with the control ferrule to control the ratcheting direction or to prevent rotation of the sleeve member with respect to the ratchet body.

### CROSS-REFERENCE TO RELATED APPLICATION

This application claims the benefit of U.S. Provisional Application No. 60/695,158, filed Jun. 29, 2005, which is incorporated by reference herein in its entirety.

### BACKGROUND OF THE INVENTION

1. Field of the Invention

The present invention relates to a ratcheting device and, more particularly, to an improved ratcheting tool having clockwise, counterclockwise, and fixed ratcheting modes.

2. Description of Related Art

Ratcheting tools such as, for example, ratcheting screwdrivers, exist in many different configurations (see, e.g., U.S. Pat. No. 6,250,183 to Chiang; U.S. Pat. No. 5,711,193 to Eggert et al.; or 6,370,988 to Thompson et al.), but generally implement a rotatable gear having various pawls biased to engage the gear, wherein the pawls can be selectively disengaged from the gear, upon adjustment of a control member, to provide a ratcheting action. However, with such mechanisms, the pawls, for example, may not be sufficiently stable to provide the necessary ratcheting function. Further, for instance, the engagement between the pawl(s) and the gear may not be sufficient under severe load conditions to prevent slippage therebetween or to prevent stripping of the gear teeth of either or both of the gear and pawl(s). Additionally, the control member or select mechanism may be prone to binding, wear, or misalignment, which, in some instances, may not allow to the tool to ratchet or otherwise function as intended.

Thus, there exists a need for a ratcheting device or tool that is stable and robust, and that includes a reliable control member and/or selector mechanism.

### BRIEF SUMMARY OF THE INVENTION

The above and other needs are met by the present invention which, in one embodiment, provides a ratcheting device configured to be implemented, for example, in a ratcheting screwdriver. Such a ratcheting device is configured to allow driving tool members to be changeably engaged with a screwdriver handle. Such a ratcheting device further includes a pair of ratcheting members for providing stable and robust ratcheting, and may be actuated by a control ferrule to provide clockwise or counterclockwise ratcheting, or no ratcheting.

More particularly, in one aspect of the invention, such a ratcheting device comprises a sleeve member defining an axis and an axially-disposed tool bore, wherein the tool bore is adapted to receive a tool member capable of engaging and driving a fastener. A gear member is coaxially engaged with and rotatably fixed with respect to the sleeve member, and defines a plurality of external gear teeth. A ratchet body defines an axially-disposed sleeve bore configured to receive the sleeve member and the gear member therein. The ratchet body further defines two parallel ratchet member bores each extending transversely to the axis through a respective opening in an outward circumferential surface of the ratchet body, wherein the ratchet member bores are opposed about and at least partially intersect the sleeve bore. A control ferrule extends about the ratchet body in coaxial relation thereto. First and second ratchet members are each configured to be slidably received by one of the ratchet member bores, with each ratchet member having opposed ends and being normally biased outwardly of the respective ratchet member bore toward the corresponding opening. Each ratchet member further includes at least one gear element operably engaged therewith and configured to engage the gear teeth of the gear member. A bearing device is operably engaged with the end of the respective ratchet member disposed toward the opening.

The ratchet members are configured such that, when the control ferrule is in a first position with respect to the ratchet body, the first ratchet member is urged against the biasing thereof and into the corresponding ratchet member bore by interaction between the control ferrule and the first ratchet member bearing device such that the at least one gear element of the first ratchet member disengages the gear member and allows the sleeve member to ratchet in one of a clockwise and a counterclockwise direction with respect to the ratchet body through interaction between the gear member and the second ratchet member. When the control ferrule is in a third position with respect to the ratchet body, the second ratchet member is urged against the biasing thereof and into the corresponding ratchet member bore by interaction between the control ferrule and the second ratchet member bearing device such that the at least one gear element of the second ratchet member disengages the gear member and allows the sleeve member to ratchet in the other of the clockwise and counterclockwise directions with respect to the ratchet body through interaction between the gear member and the first ratchet member. When the control ferrule is in a second position with respect to the ratchet body, neither of the ratchet members is urged against the biasing thereof and into the corresponding ratchet member bore by interaction between the control ferrule and the corresponding bearing device, and the at least one gear element of each of the ratchet members remains engaged with the gear member, thereby preventing the sleeve member from rotating with respect to the ratchet body.

Embodiments of the present invention thus provide significant advantages as described further herein.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 is perspective view of a ratchet device according to one embodiment of the present invention, as well as such a ratchet device implemented in connection with a handle member and a tool member;

FIGS. 2-4 are various exploded views of a ratchet device according to one embodiment of the present invention as shown in FIG. 1;

FIG. 5 is a perspective view of a ratchet device according to one embodiment of the present invention as shown in FIG. 1 illustrating an operational mode of the ratchet device;

FIG. 6 is an axial view of a ratchet device according to one embodiment of the present invention as shown in FIG. 1 illustrating an operational mode of the ratchet device; and

FIGS. 7-9 are axial cross-sectional views of a ratchet device according to one embodiment of the present invention as shown in FIGS. 5 and 6 illustrating three operational modes of the ratchet device.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

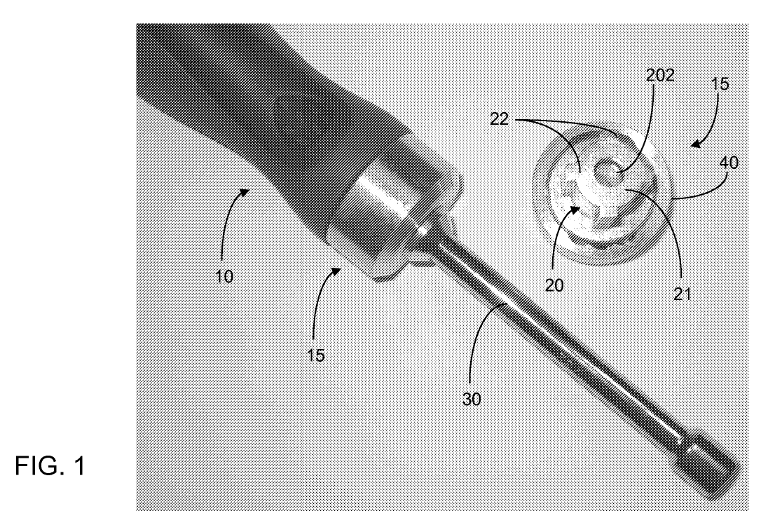

FIG. 1 illustrates one embodiment of a ratcheting device according to the present invention, the ratcheting device being generally indicated by the numeral 15. Such a ratcheting device 15 may, in some instances, be engaged with a handle member 10 via a bore (not shown) defined thereby and having one or more axial grooves (not shown) formed in one end thereof. In such instances, the ratcheting device 15 includes a ratchet body 20 with an axially-extending body portion 21 having one or more axial ribs 22 protruding therefrom and configured to engage the grooves of the handle member 10. The ratchet body 20 thus engaged with the handle member 10 through the rib 22/groove interaction is prevented from rotating relative to the handle member 10. That is, any rotation of the handle member 10 would thus, in turn, cause the ratchet body 20 to rotate therewith. In one embodiment, the body portion 21 of the ratchet body 20 is, for example, press fit into the bore of the handle member 10.

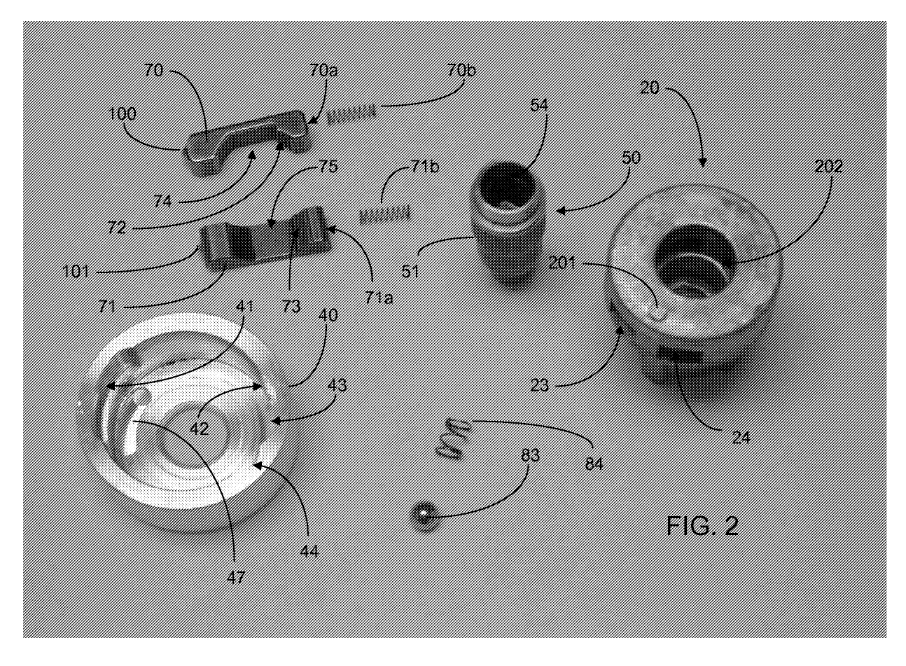

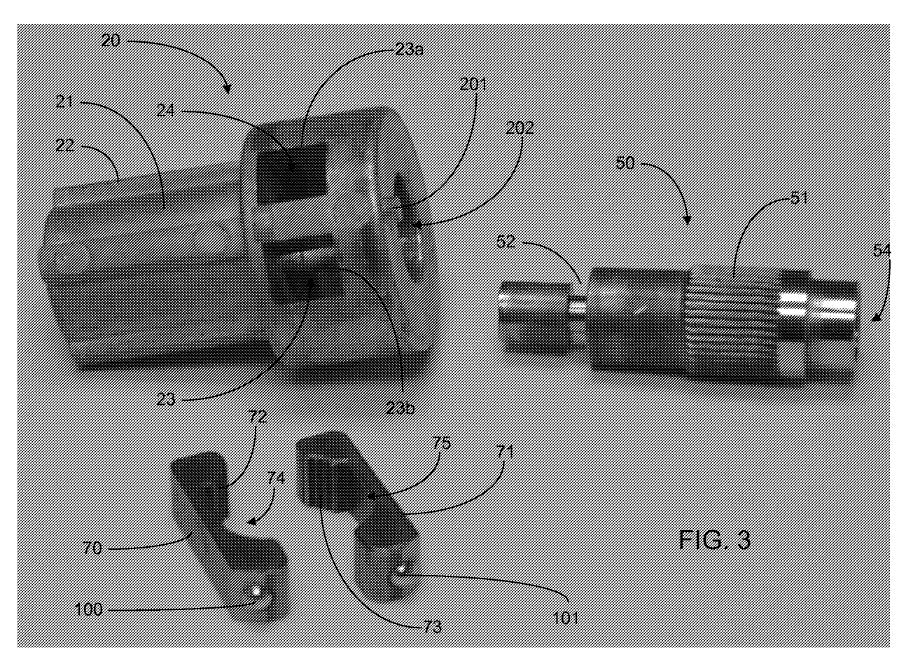

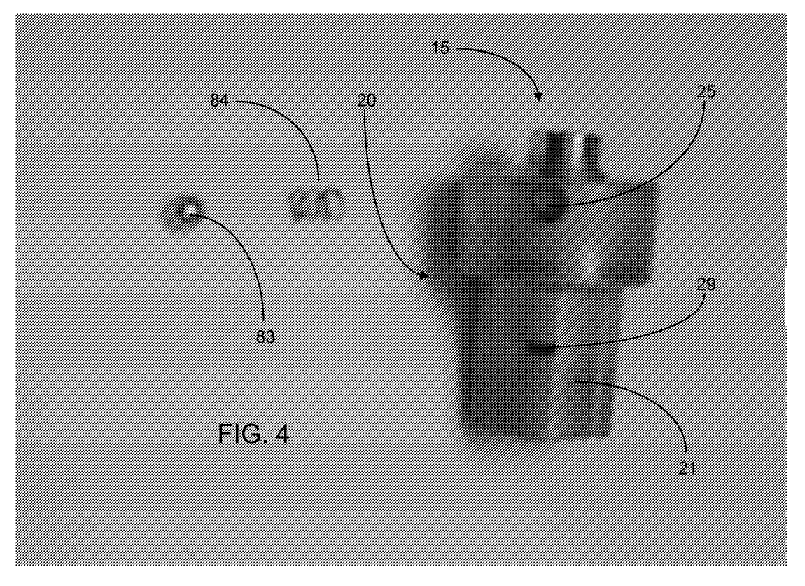

As shown in FIGS. 2 and 3, an elongate sleeve member 50 is received in an axially-extending sleeve bore 202 defined by the ratchet body 20, wherein the sleeve member 50 includes a gear member 51 formed thereon or otherwise operably engaged therewith, the gear member 51 having external gear teeth. In one embodiment, the gear member 51 may be disposed toward one end of the sleeve member 50. In some embodiments, the sleeve member 50 further includes an annular groove 52 defined thereby. In such instances, the body portion 21 of the ratchet body 20 defines a slot 29 (FIG. 4) corresponding to the annular groove 52 of the sleeve member 50, when the sleeve member 50 is inserted into the sleeve bore 202 of the ratchet body 20. The slot 29 is configured to receive a key (not shown) therethrough, wherein the key is configured to extend between the slot 29 and the annular groove 52 for axially securing the sleeve member 50 in the ratchet body 20, while allowing the sleeve member 50 to rotate with respect to the ratchet body 20. The sleeve member 50 further defines an axially-extending tool bore 54 configured to slidably receiving a tool member 30 (FIG. 1), wherein, in some instances, the tool member 30 is capable of engaging and driving a fastener (not shown).

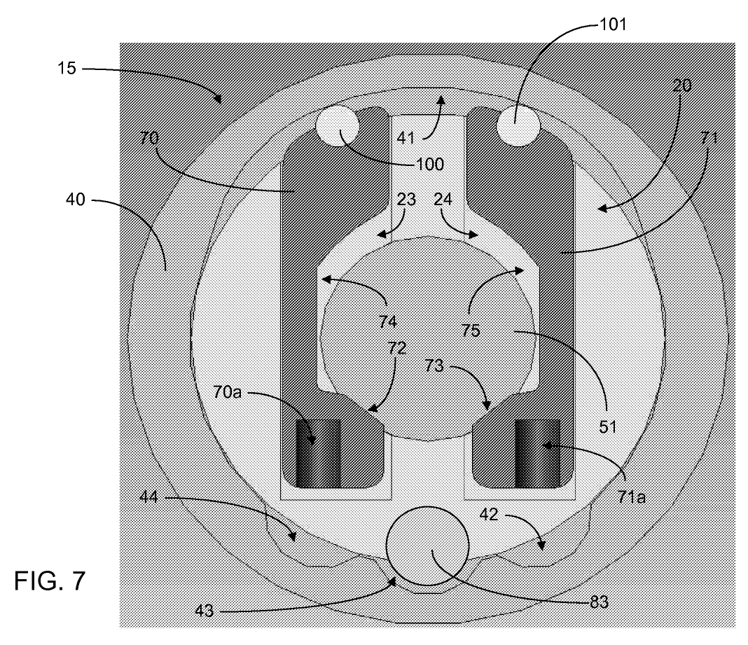

As shown in FIGS. 2 and 3, the ratchet body 20 defines two parallel ratchet member bores 23, 24 extending transversely to the axis of the ratchet body 20 through respective openings 23a, 24a in an outward circumferential surface of the ratchet body 20. The ratchet member bores 23, 24 are opposed about the sleeve bore 202 and at least partially intersect the sleeve bore 202 so as to be in communication therewith (as better shown, for example, in FIG. 7). The ratchet member bores 23, 24 are configured to slidably receive a pair of ratchet members or pawls 70, 71, respectively, through the openings 23a, 24a, wherein the pawls 70, 71 are normally biased outwardly of the ratchet member bores 23, 24. The biasing of the pawls 70, 71 may be accomplished, for example, with a biasing device such as a coil spring 70b, 71b (FIG. 2) disposed between the respective pawls 70, 71 and the ratchet body 20. In one embodiment, the end of each pawl 70, 71 first received by the ratchet member bore 23, 24 defines a spring bore 70a, 71a (FIG. 2) for receiving the respective coil spring 70b, 71b. However, such spring bores 70a, 71a may, in other instances, be defined by the ratchet body 20 about the ends of the ratchet member bores 23, 24 receiving the pawls 70, 71. One skilled in the art will appreciate, however, that the pawls 70, 71 may be biased outwardly from the ratchet body 20 in many different manners such as shown, for example, in U.S. Pat. No. 6,250,183 to Chiang.

As shown in FIGS. 2, 3, and 7, the pawls 70, 71 are generally “C”-shaped and each defines a depression 74, 75 for receiving the gear member 51 therein, when the pawls 70, 71 and the sleeve member 50 are installed in the ratchet body 20. The pawls 70, 71 each further includes one or more gear elements, such as teeth 72, 73, arranged about the respective depressions 74, 75 and configured to engage with the gear member 51 when the pawls 70, 71 are biased outwardly of the respective ratchet member bores 23, 24. In some instances, the pawls 70, 71 and the channels 23, 24 of the ratchet body 20 are configured to have complementary non-circular cross-sections such that the pawls 70, 71 are guided to slide along the channels 23, 24 of the ratchet body 20 without rotating relative to the ratchet body 20.

According to embodiments of the present invention, as shown in FIGS. 2, 3, 5, and 6, the ends of the pawls 70, 71 last received by the ratchet member bores 23, 24 (i.e., the ends of the pawls 70, 71 disposed toward the openings 23a, 24a) are each configured to have a bearing device 100, 101 operably engaged therewith. In one embodiment, only the bearing devices 100, 101 extend outwardly past the circumferential surface of the ratchet body 20 defining the openings 23a, 24a when the pawls 70, 71 and the sleeve member 50 are installed in the ratchet body 20. The bear devices 100, 101 may each comprise, for example, a ball bearing installed in a receptacle defined in the end of each pawl 70, 71 such that each ball bearing is capable of freely rotating when installed. One skilled in the art will appreciate, however, that the bearing devices 100, 101 may be provided in many different forms and may comprise, for example, one or more roller bearings or a surface layer, or a strip comprised of, for instance, polytetrafluoroethylene, or any other suitable arrangement for facilitating the movement of a surface in contact with the bearing device 100, 101.

As shown in FIGS. 2, 5, and 6, a control ferrule 40 is configured to be received onto and over the ratchet body 20 so as to at least extend over the bearing devices 100, 101 engaged with the pawls 70, 71. The control ferrule 40 is further configured to be rotatable with respect to the ratchet body 20. In some instances, the control ferrule 40 defines an arcuate slot 47 corresponding to and capable of receiving a pin member 201 extending from the ratchet body 20 for limiting the rotational movement of the control ferrule 40 relative to the ratchet body 20. One skilled in the art will appreciate, however, the limiting the rotational movement of the control ferrule 40 with respect to the ratchet body 20 may be accomplished in many different manners such as, for example, complementary non-circular shaped profiles of the control ferrule 40 and the ratchet body 20 for allowing only limited rotation. In addition, one skilled in the art will appreciate that, alternatively, the arcuate slot 47 may be defined by the ratchet body 20, while the pin member 201 extends from the control ferrule 40 for engaging the arcuate slot 47 and limiting the rotation of the control ferrule 40 with respect to the ratchet body 20.

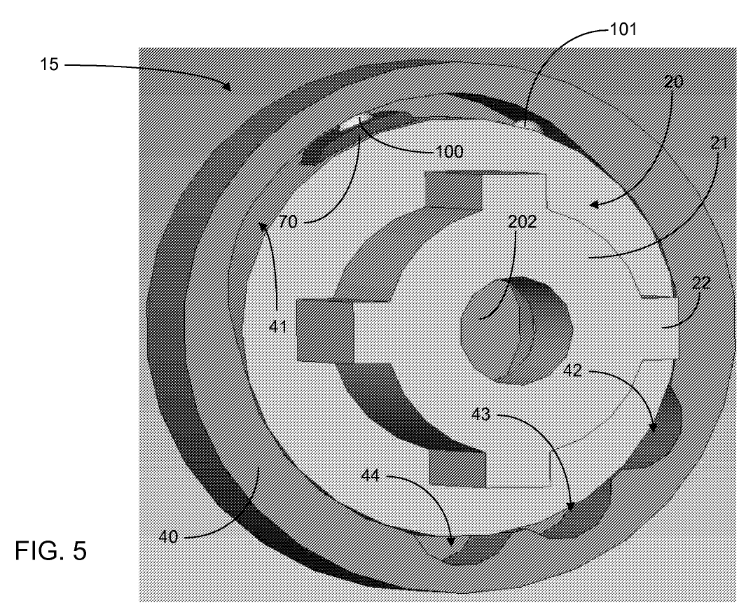

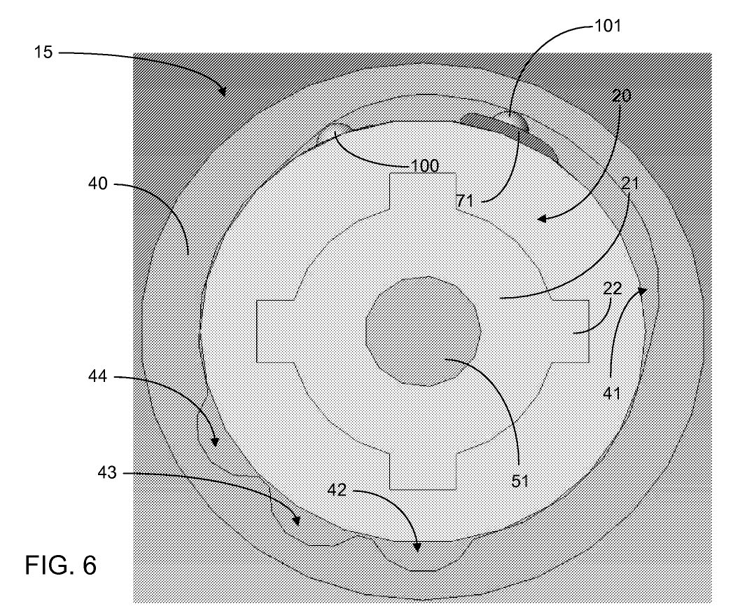

In some instances, the rotational position of the control ferrule 40 with respect to the ratchet body 20 is determined, for example, by a ratchet selector device engaged therebetween, where such a ratchet selector device is actuatable to direct the control ferrule 40 between first, second, and third rotational or angular positions with respect to the ratchet body 20, as shown in FIGS. 5 and 6. In one such embodiment, the control ferrule 40 includes an inner peripheral portion or surface defining three detent recesses 42, 43, 44, the detent recesses 42, 43, 44 corresponding to the first, the second, and the third rotational position, respectively, of the control ferrule 40 with respect to the ratchet body 20. In such an embodiment, the ratchet selector device may comprise, for instance, a projection 83 (FIGS. 2-4) operably engaged with the ratchet body 20 and biased outwardly thereof toward the detent recesses 42, 43, 44, the projection 83 cooperating with the detent recesses 42, 43, 44 to determine the selected angular position of the control ferrule 40 relative to the ratchet body 20 (FIGS. 5-9). The projection 83 may comprise, for example, a ball bearing biased by a coil spring 84 outwardly of a ratchet selector bore 25 defined by the ratchet body 20. As such, as the control ferrule 40 is rotated with respect to the ratchet body 20, the coil spring and ratchet selector bore 25 cooperate to allow the projection 83 to be urged into the ratchet selector bore 25 as the projection 83 passes between adjacent ones of the detent recesses 42, 43, 44, whereby the coil spring 84 then urges the projection 83 outwardly of the ratchet selector bore 25 to engage the corresponding detent recess, when that detent recess and the ratchet selector bore 25 are rotationally aligned, to provide a detent mechanism between the control ferrule 40 and the ratchet body 20. In this manner, the control ferrule 40 can be moved between the first, second, and third rotational positions with respect to the ratchet body 20.

The control ferrule 40 further defines a controller recess 41 extending radially outward from the inner peripheral portion thereof. In some instances, the inner peripheral portion may be configured to be circular (i. e., having a defined radius) such that the sleeve member 50 is capable of rotating therein. The controller recess 41 may thus be any increase in the dimension of the inner peripheral portion extending radially outward therefrom. As such, the controller recess 41 may be defined on either end thereof by a tapered step extending radially outward of the inner peripheral portion as shown, for example, in FIG. 2. In other instances, the controller recess 41 may be defined on either end by a gradual increase in dimension in the radially outward direction from the inner peripheral portion as shown, for example, in FIGS. 5-9. One skilled in the art will appreciate, however, that the purpose of such a controller recess 41, as further described herein, may be accomplished in different manners in accordance with the spirit and scope of the present invention., and that the configurations of thus described herein are for exemplary purposes only and are not intended to be limiting in this respect.

The controller recess 41 is configured such that, when the projection 83 is engaged with the second detent recess 43 (whereby the control ferrule 40 is in the second rotational position with respect to the ratchet body 20), the bearing devices 100, 101 associated with both pawls 70, 71 are received by the controller recess 41 (FIG. 7). Since both bearing devices 100, 101 are received by the controller recess 41, the pawls 70, 71 are both biased outwardly of the ratchet body 20 such that the respective gear elements 72, 73 engage the gear member 51. Accordingly, with the control ferrule 40 in the second position with respect to the ratchet body 20, both pawls 70, 71 are engaged with the gear member 51 and thus prevents the sleeve member 50 from rotating in either a clockwise or a counterclockwise direction with respect to the ratchet body 20. As such, if the ratcheting device 15 is implemented in, for example, a screwdriver, the locked nature of the sleeve member 50 with respect to the ratchet body 20 would cause that screwdriver to function as a conventional screwdriver lacking the ratcheting device 15 (i.e., rotating the handle 10 in either a clockwise direction or a counterclockwise direction would cause the sleeve member 50 and any tool member 30 inserted therein to turn in that same direction, and the operation of the screwdriver would not include ratcheting in either direction).

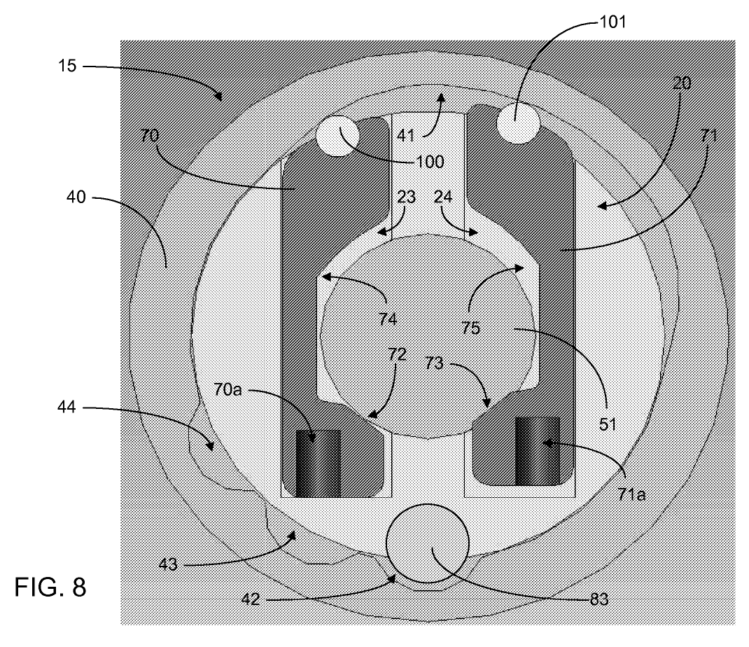

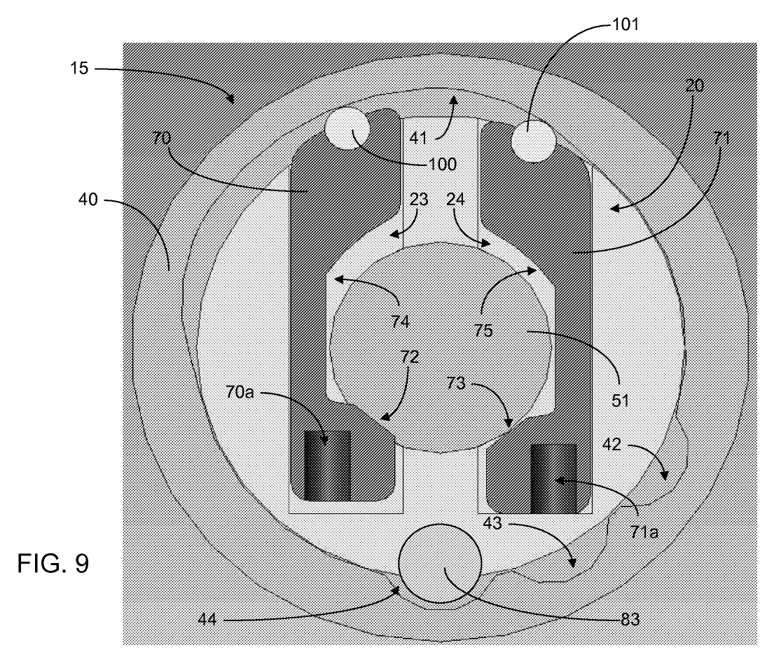

When the control ferrule 40 is moved to either of the first (FIG. 8) or third (FIG. 9) rotational position (the projection 83 engaging the first detent recess 42 or the third detent recess 44, respectively), the controller recess 41 is further configured such that one of the pawls 70, 71 moves outside of the controller recess 41 to engage the inner peripheral portion of the controller ferrule 40 disposed radially inward of the controller recess 41. That is, the transition of one of the bearing devices from the controller recess 41 to the radially inward inner peripheral portion of the ratchet body 20 causes the corresponding pawl to be urged against the biasing member biasing that pawl outwardly of the ratchet body 20, and into the ratchet member bore. In this manner, the pawl is urged back into the corresponding ratchet member bore, causing the gear element(s) thereof to disengage from the gear member 51. In one embodiment, the sleeve member 50 is then allowed to ratchet in the direction of the pawl/bearing member remaining in or in correspondence with the controller recess 41, but is locked in the direction of the pawl/bearing member engaged with the inner peripheral portion of the ratchet body 20. As such, the driving direction of the ratchet device 15 can be controlled to drive in the clockwise direction and ratchet in the counterclockwise direction (tightening a fastener with right-hand threads) or to drive in the counterclockwise direction and ratchet in the clockwise direction (loosening the fastener).

In operation, when the control ferrule 40 is in the first position (FIG. 8) with respect to the ratchet body 20, the second pawl 71 is urged against the biasing thereof and into the corresponding ratchet member bore 24 by interaction between the inner peripheral portion of the control ferrule 40 and the second pawl bearing device 101 such that the gear element 73 of the second pawl 71 disengages the gear member 51 and allows the sleeve member 50 to ratchet in the counterclockwise direction (and drive in the clockwise direction) with respect to the ratchet body 20 through interaction between the gear member 51 and the first pawl 70. When the control ferrule 40 is rotated to the second position with respect to the ratchet body 20, neither of the pawls 70, 71 is urged against the biasing thereof and into the corresponding ratchet member bore 23, 24 by interaction between the inner peripheral portion of the control ferrule 40 and the corresponding bearing device 100, 101, since both bearing devices 100, 101 are received by the controller recess 41, and the gear element 72, 73 of both of the pawls 70, 71 remains engaged with the gear member 51, thereby preventing the sleeve member 50 from rotating with respect to the ratchet body 20 (FIG. 7). As such, the sleeve member 50 is locked with respect to the ratchet body 20 and is thus configured to drive in both the clockwise and counterclockwise directions with no ratcheting in either direction. When the control ferrule 40 is rotated to the third position (FIG. 9) with respect to the ratchet body 20, the first pawl 70 is urged against the biasing thereof and into the corresponding ratchet member bore 23 by interaction between the inner peripheral portion of the control ferrule 40 and the first pawl bearing device 100 such that the gear element 72 of the first pawl 70 disengages the gear member 51 and allows the sleeve member 50 to ratchet in the clockwise direction (and drive in the counterclockwise direction) with respect to the ratchet body 20 through interaction between the gear member 51 and the second pawl 71.

As shown in FIG. 1, the tool bore 54 of the sleeve member 50 is configured to receive a tool member 30. In some instances, the tool bore 54 is configured to have a non-circular cross-section such that the tool member 30 received thereby is prevented from rotating with respect to the sleeve member 50. The tool member 30 may comprise, for example, a hex-head driver bit, a screwdriver bit, adapters and/or extension members therefor, or any other suitable tool device capable of benefiting from a forward and reverse ratcheting receiver. In some instances, the tool member 30 may be configured as shown, for example, in U.S. Pat. No. 6,250,183 to Chiang, whereby the tool member 30 may comprise a reversible tool holder having opposed ends configured to receive double-ended driver bits. The ratchet device 15 may thus be configured to receive and/or include various kinds of tool members 30 or tool bits therewith and as appropriate.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A ratcheting device, comprising:
a sleeve member defining an axis and an axially-disposed tool bore, the tool bore being adapted to receive a tool member capable of engaging and driving a fastener;
a gear member coaxially engaged with and rotatably fixed with respect to the sleeve member, the gear member defining a plurality of external gear teeth;
a ratchet body defining an axially-disposed sleeve bore configured to receive the sleeve member and the gear member therein, the ratchet body further defining two parallel ratchet member bores each extending transversely to the axis through a respective opening in an outward circumferential surface of the ratchet body, with the ratchet member bores being opposed about and at least partially intersecting the sleeve bore;
a control ferrule extending about the ratchet body in coaxial relation thereto; and
first and second ratchet members each configured to be slidably received by one of the ratchet member bores, each ratchet member having opposed ends and being normally biased outwardly of the respective ratchet member bore toward the corresponding opening, each ratchet member further including at least one gear element operably engaged therewith and configured to engage the gear teeth of the gear member, and a bearing device operably engaged with the end of the respective ratchet member disposed toward the opening;
the ratchet members being configured such that, when the control ferrule is in a first position with respect to the ratchet body, the first ratchet member is urged against the biasing thereof and into the corresponding ratchet member bore by interaction between the control ferrule and the first ratchet member bearing device such that the at least one gear element of the first ratchet member disengages the gear member and allows the sleeve member to ratchet in one of a clockwise and a counterclockwise direction with respect to the ratchet body through interaction between the gear member and the second ratchet member;
and such that when the control ferrule is in a third position with respect to the ratchet body, the second ratchet member is urged against the biasing thereof and into the corresponding ratchet member bore by interaction between the control ferrule and the second ratchet member bearing device such that the at least one gear element of the second ratchet member disengages the gear member and allows the sleeve member to ratchet in the other of the clockwise and counterclockwise directions with respect to the ratchet body through interaction between the gear member and the first ratchet member;
and such that when the control ferrule is in a second position with respect to the ratchet body, neither of the ratchet members is urged against the biasing thereof and into the corresponding ratchet member bore by interaction between the control ferrule and the corresponding bearing device, and the at least one gear element of each of the ratchet members remains engaged with the gear member, thereby preventing the sleeve member from rotating with respect to the ratchet body.

2. A ratcheting device according to claim 1 further comprising a ratchet selector device operably engaged between the ratchet body and the control ferrule, the ratchet selector device being actuatable so as to direct the control ferrule between the first, second, and third positions with respect to the ratchet body.

3. A ratcheting device according to claim 1 wherein a ratchet selector device is operably engaged with the ratchet body and the control ferrule defines three detent recesses in a surface thereof disposed toward the ratchet body, the three detent recesses corresponding the first, second, and third positions of the control ferrule with respect to the ratchet body, the control ferrule being rotatably movable with respect to the ratchet body, and the ratchet selector device being configured to interact with any of the three detent recesses to retain the control ferrule in the corresponding one of the first, second, and third positions with respect to the ratchet body.

4. A ratcheting device according to claim 3 wherein the ratchet selector device further comprises a bearing member biased outwardly of the ratchet body and configured to interact with any of the three detent recesses defined by the control ferrule.

5. A ratcheting device according to claim 3 wherein the ratchet selector device further comprises a ball bearing biased outwardly of the bearing member by a coil spring, the ball bearing and the coil spring being received by a ratchet selector bore defined by the ratchet body, the ball bearing being configured to interact with any of the three detent recesses defined by the control ferrule.

6. A ratcheting device according to claim 1 wherein the bearing device operably engaged with each of the ratchet members further comprises a ball bearing rotatably retained by the respective ratchet member.

7. A ratcheting device according to claim 1 further comprising a coil spring disposed between each of the ratchet members and the ratchet body for biasing the respective ratchet member outwardly of the ratchet body.

8. A ratcheting device according to claim 1 wherein the control ferrule further defines a controller recess in a surface thereof disposed toward the ratchet body, the control recess being configured to receive the bearing devices of both ratchet members when the control ferrule is in the second position with respect to the ratchet body, the second ratchet member bearing device when the control ferrule is in the first position, and the first ratchet member bearing device when the control ferrule is in the third position, the control ferrule being further configured to urge one of the ratchet members against the biasing thereof and into the corresponding ratchet member bore if the bearing device of that ratchet member is not received by the controller recess.

9. A ratcheting device according to claim 3 wherein the control ferrule further defines a controller recess in a surface thereof disposed toward the ratchet body and configured to selectively at least one of the ratchet member bearing devices depending on the position of the control ferrule with respect to the ratchet body, the control recess being substantially diametrically opposed to the three detent recesses.

10. A ratcheting device according to claim 1 wherein one of the control ferrule and the ratchet body includes a pin member operably engaged therewith, and the other of the control ferrule and the ratchet body defines a complementary slot configured to receive the pin, the pin and the slot cooperating to limit the rotation of the control ferrule with respect to the ratchet body to between the first, second, and third positions.

11. A ratcheting device according to claim 1 wherein the ratchet body is configured to be received by a handle member, the ratchet body being non-rotatable with respect to the handle member and cooperable therewith to rotate the tool member engaged with the sleeve member.
